(19) United States
(12) Patent Application Publication
(10) Pub. No.: US 2012/0139990 A1
(43) Pub. Date: Jun. 7, 2012

(54) Print Head Vacuum Relief Mechanism

(76) Inventors: Casey E. Walker, Boulder, CO (US); Stuart J. Boland, Denver, CO (US)

(21) Appl. No.: 12/959,077

(22) Filed: Dec. 2, 2010

(51) Int. Cl. B41J 29/393; B41J 2/165

(52) U.S. Cl. 347/19; 347/30

(57) ABSTRACT

A method is disclosed. The method includes monitoring a sensor for measured vacuum pressure within a print head, determining if the vacuum pressure measured at the sensor is less than a predetermined pressure threshold and indicating that the print head is ready to be decoupled from the maintenance station if the measured vacuum pressure is less than the predetermined pressure threshold.

### FIELD OF THE INVENTION

This invention relates generally to the field of ink jet printing systems. More particularly, the invention relates to maintaining a print head within an ink jet printing system.

### BACKGROUND

An ink jet printer is an example of a printing apparatus that ejects droplets of ink onto a recording medium, such as a sheet of paper, for printing an image on the recording medium. The ink jet printer includes a print engine having one or more ink jet print heads provided with an ink cartridge that accommodates the ink. In operation of the print engine, the ink is supplied from the ink cartridge to each ink jet print head having ejection nozzles, so that a printing operation is performed by ejection of the ink droplets from selected ejection nozzles.

However, ink jet printers may suffer from one or more problems leading to nozzle clogging and the inability to fire an ink droplet under normal conditions. A clogged nozzle may not only result in diminished print quality, but may also require the expense of replacing the entire ink jet print head. Thus, ink jet print heads are regularly maintained to ensure usability.

Maintenance of ink jet print heads typically involves a maintenance station, including an array of print head caps, hoses, manifolds, pumps, valves etc., that generate a vacuum that is used to pull ink through the print head to the maintenance station. Further, an ambient air system is implemented to relieve the vacuum prior to uncapping a capped print head after vacuum has been applied through the maintenance station. However, if the vacuum is not sufficiently relieved before releasing the print heads from the maintenance station, damage to the print head may occur (e.g., nozzle plates may be dislodged from the print head or the print head caps may be damaged resulting in costly part replacement and downtime).

Current systems release the print heads after a predetermined time period. However, with the use of inks having different viscosities, the time period for the vacuum in the print head to become sufficiently relieved may vary. For instance low viscosity inks may take only several seconds for sufficient vacuum relief, while a higher viscosity ink may take several minutes. Thus, the predetermined time period must be set for the higher threshold, even if the actual relief time may be substantially less; or an ambient vacuum relief system and associated extra hardware is required to relieve the vacuum.

Therefore, a system to monitor vacuum applied to a print head is desired.

### SUMMARY

In one embodiment, a method is disclosed. The method includes monitoring a sensor for measured vacuum pressure applied to a print head, determining if the vacuum pressure measured at the sensor is less than a predetermined pressure threshold and indicating that the print head is ready to be decoupled from the maintenance station if the measured vacuum pressure is less than the predetermined pressure threshold.

In a further embodiment, a system is disclosed. The system includes a print engine having a sensor to measure vacuum pressure applied to the print head, a maintenance station coupled to pull ink from the print head via a vacuum, and a control to monitor the sensor and to determine if the vacuum pressure measured at the sensor is less than a predetermined pressure threshold.

### BRIEF DESCRIPTION OF THE DRAWINGS

A better understanding of the present invention can be obtained from the following detailed description in conjunction with the following drawings, in which:

FIG. 1 illustrates one embodiment of a system;

FIG. 2 illustrates one embodiment of a maintenance station; and

FIG. 3 is a flow diagram illustrating one embodiment of vacuum relief.

### DETAILED DESCRIPTION

A mechanism to monitor vacuum for print head release is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

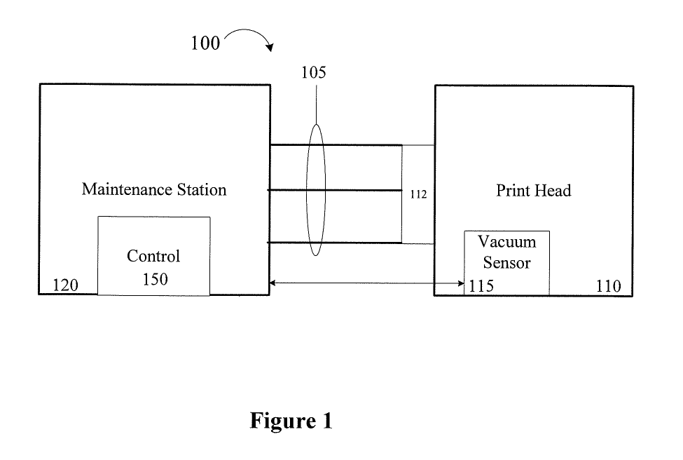

FIG. 1 illustrates one embodiment of a system 100. System 100 includes a print head 110 and a maintenance station 120. In one embodiment, print head 110 is a component of an ink jet print engine that supplies ink from an ink cartridge to a medium via multitude of nozzles. In a further embodiment, print head 110 includes a vacuum sensor 115 that monitors vacuum pressure applied to print head 110 during maintenance.

In such an embodiment, vacuum sensor 115 is an electronic vacuum gauge that is electrically coupled to maintenance station 120 to provide feedback signals. However in other embodiments, other types of pressure sensors may be implemented.

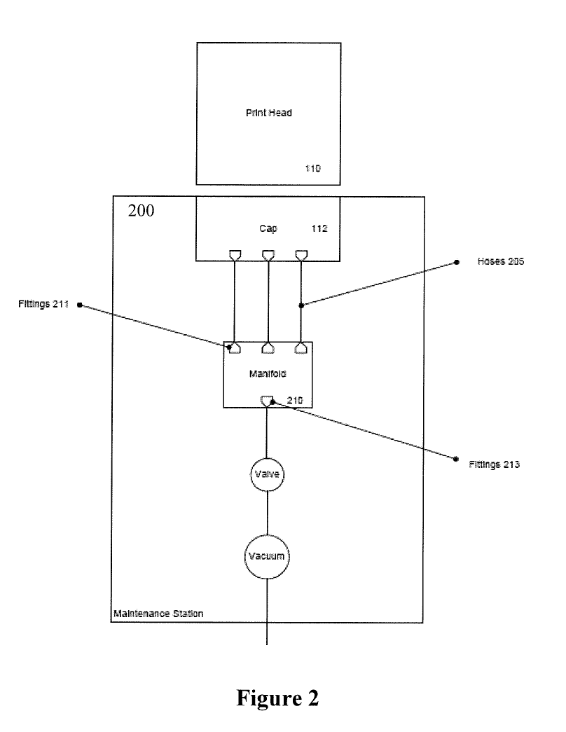

Maintenance station 120 is used to maintain print head 110 by pulling ink through and from print head 110 to maintenance station 120 via a vacuum source. Thus, maintenance station 120 is also coupled to print head 110 by caps 112, which attach to print head 110, and hoses 105. FIG. 2 illustrates one embodiment of maintenance station 200 corresponding to maintenance station 120 shown in FIG. 1.

Maintenance station 200 includes a manifold 210 having fittings 211 for coupling to hoses 205. Hoses 205 are coupled to print head caps, which are coupled to print head 110, and are implemented to carry ink from print head 110 to manifold 210. Maintenance station 200 also includes fittings 213 coupled at an end of manifold 210. In one embodiment, each of fittings 213 are coupled to a valve and a vacuum source via a hose to provide the vacuum to manifold 210.

A vacuum is provided at each respective fitting 213. Thus, the vacuum presented at fitting 213 enables ink to be pulled into manifold 210 from a print head via hoses 205 and fittings 211, and out through fittings 213. In other embodiments, separate ambient air ports may be provided to relieve the vacuum in order to prevent damage to the print head prior to removing a cap at the print head. According to one embodiment, all components of maintenance station 200 are composed of polypropylene. However in other embodiments, other materials are used for one or more of the components of maintenance station 200.

Referring back to FIG. 1, maintenance station 120 also includes a control 150. Control 150 controls the print head 110 maintenance process by starting and stopping a vacuum cleaning sequence. According to one embodiment, control 150 receives feedback signals from vacuum sensor 115. In such an embodiment, control 150 monitors the signals from vacuum sensor 115 once the cleaning sequence has ended in order to determine whether vacuum pressure measured at print head 110 by vacuum sensor 115 has been sufficiently relieved. Once the pressure is determined to be below a predetermined pressure threshold, caps 112 may be disconnected from print head 110. For example, the print head caps may disengage when the vacuum is below 1 kPa. Although described above as included in maintenance station 120, other embodiments may be implemented in which control 150 is external to maintenance station 120.

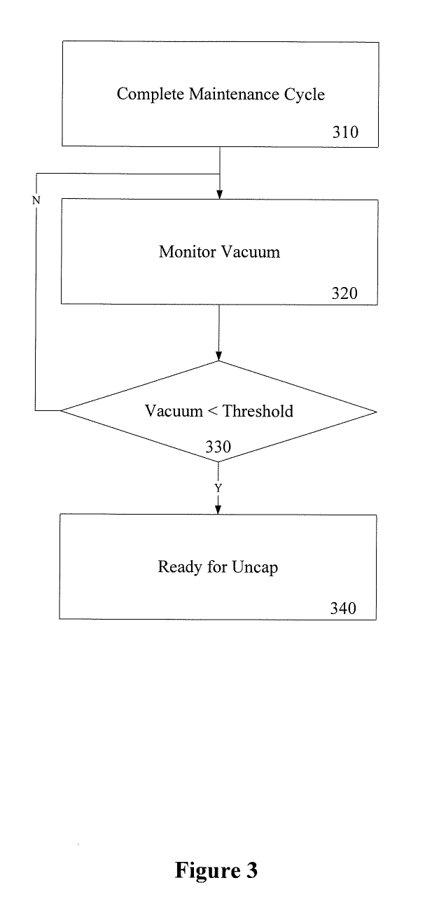

FIG. 3 is a flow diagram illustrating one embodiment of vacuum relief. At processing block 310, the maintenance cycle in system 100 is completed. At processing block 320, control 150 begins monitoring feedback signals received from vacuum sensor 115. At decision block 330, it is determined whether the signals indicate that the vacuum pressure measured by vacuum sensor 115 is less than the predetermined pressure threshold.

If so, print head 110 is ready to be uncapped from maintenance station 120, processing block 340. In one embodiment, maintenance station 120 provides an audio and/or visual indication that the print head 110 is ready to be uncapped. In another embodiment, maintenance station 120 provides an indication internal to a print engine. For example, the print engine may cause print head 110 to uncap and continue with the cleaning cycle once the vacuum has reached the acceptable level, thereby producing a closed-loop system.

If it is determined that the measured vacuum pressure is greater than the predetermined pressure threshold, control is returned to processing block 320, where control 150 continues to monitor the signals from vacuum sensor 115 until the vacuum pressure falls below the predetermined pressure threshold.

The above-described mechanism extends the life of print heads, and reduces service costs by ensuring that print heads are not uncapped prematurely.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A system comprising:
a print head having a sensor to measure vacuum pressure applied to the print head;
a maintenance station coupled to pull ink from the print head via a vacuum; and
a control to monitor the sensor and to determine if the vacuum pressure measured at the sensor is less than a predetermined pressure threshold.

2. The system of claim 1 wherein the control provides an indication that the print head is ready to be decoupled from the maintenance station if determined that the measured vacuum pressure is less than the predetermined pressure threshold.

3. The system of claim 2 wherein the indication is a visual indication.

4. The system of claim 2 wherein the indication is an audio and visual indication.

5. The system of claim 1 wherein the control continues to monitor the sensor if determined that the measured vacuum pressure is greater than the predetermined pressure threshold.

6. The system of claim 1 wherein the control monitors the sensor by receiving feedback signals from the sensor.

7. A method comprising:
monitoring a sensor for measured vacuum pressure within a print head;
determining if the vacuum pressure measured at the sensor is less than a predetermined pressure threshold; and
indicating that the print head is ready to be decoupled from the maintenance station if the measured vacuum pressure is less than the predetermined pressure threshold.

8. The method of claim 7 further comprising continue monitoring the sensor if the measured vacuum pressure is greater than the predetermined pressure threshold.

9. The method of claim 7 further comprising terminating a cleaning sequence at the print head prior to monitoring the sensor.

10. The method of claim 7 wherein monitoring the sensor comprises receiving feedback signals from the sensor.

11. The method of claim 7 further comprising providing an indication that the print head is ready to be decoupled from the maintenance station.

12. A print head maintenance station comprising:
one or more caps coupled to a print head;
one or more hoses coupled to the caps; and
a manifold coupled to the hoses; and
a control to monitor the sensor and to determine if vacuum pressure applied to a print head is less than a predetermined pressure threshold

13. The print head maintenance station of claim 12 wherein the control provides an indication that the print head is ready to be decoupled from the maintenance station if determined that the measured vacuum pressure is less than the predetermined pressure threshold.

14. The print head maintenance station of claim 12 wherein the control continues to monitor the sensor if determined that the measured vacuum pressure is greater than the predetermined pressure threshold.

15. The print head maintenance station of claim 12 wherein the control monitors the sensor by receiving feedback signals from the sensor.

16. An article of manufacture comprising a machine-readable medium including data that, when accessed by a machine, cause the machine to perform operations comprising:
monitoring a sensor for measured vacuum pressure applied to a print head;
determining if the vacuum pressure measured at the sensor is less than a predetermined pressure threshold; and
indicating that the print head is ready to be decoupled from the maintenance station if the measured vacuum pressure is less than the predetermined pressure threshold

17. The article of manufacture of claim 16 when accessed by the machine, further cause the machine to perform operations comprising continue monitoring the sensor if the measured vacuum pressure is greater than the predetermined pressure threshold.

18. The article of manufacture of claim 16 when accessed by the machine, further cause the machine to perform operations comprising terminating a cleaning sequence at the print head prior to monitoring the sensor.

19. The article of manufacture of claim 16 wherein monitoring the sensor comprises receiving feedback signals from the sensor.

20. The article of manufacture of claim 16 when accessed by the machine, further cause the machine to perform operations comprising providing an audio/visual indication that the print head is ready to be decoupled from the maintenance station.
